(19) United States
(12) Patent Application Publication
(10) Pub. No.: US 2011/0018975 A1
(43) Pub. Date: Jan. 27, 2011

(54) STEREOSCOPIC IMAGE GENERATING METHOD AND SYSTEM

(76) Inventors: Shih-Han Chen, Taipei City (TW); Wen-Kuo Lin, Taipei City (TW)

Correspondence Address: Patterson & Sheridan, LLP - THRONE, 3040 Post Oak Blvd, Suite 1500, Houston, TX, 77056, US

(21) Appl. No.: 12/689,032

(22) Filed: Jan. 18, 2010

(30) Foreign Application Priority Data
Jul. 21, 2009 (TW) 098124549

(51) Int. Cl. H04N 13/02

(52) U.S. Cl. 348/50; 348/E13.074

(57) ABSTRACT

The invention discloses a stereoscopic image generating method including the steps of capturing a first image and a second image from two different view angles, wherein the two images have a common primary target and a common secondary target; recognizing the common secondary target; analyzing respective capture information of the secondary target in the first image and the second image; according to the respective capture information in the first image and the second image, generating an image object placed in the first image and the image object placed in the second image; and according to an arrangement criterion, arranging the pixels of the first image, the pixels of the second image, the pixels of the image object placed in the first image and the pixels of the image object placed in the second image to generate a single mixed image.

### BACKGROUND OF THE INVENTION

1. Field of the Invention

The present invention relates to a stereoscopic image generating system and a stereoscopic image generating method, making the primary capture target and the accompanied image objects in an image have stereoscopic effects.

2. Description of the Prior Art

Up to now, the stereoscopic image known in the market is generally realized by making a primary capture target in the image stereoscopic. Although the stereoscopic image presented in this way has the stereoscopic effect, what is stereoscopic is only the primary capture target; that is, other objects in the image can not have the same stereoscopic effect. In short, the image obtained by the traditional technique of mixed reality lacks having a universal stereoscopic effect.

### SUMMARY OF THE INVENTION

An aspect of the invention is to provide a stereoscopic image generating system for generating a stereoscopic image accompanied with an image object. It is particular that the image object applies the capture information of the original captured image. When a person observes the stereoscopic image within a predetermined observation scope, the stereoscopic image can provide the best visual effect relative to where the person locates.

According to an embodiment of the invention, the stereoscopic image generating system includes an image capturing module, an image recognizing module, an image generating module, and an image mixing module.

The image capturing module is for capturing a first image and a second image at two different view angles, wherein the two images have a common primary capture target and a common secondary capture target. The image recognizing module is for identifying the common secondary capture target and recognizing respective capture information of the common secondary capture target in the first image and the second image.

In an embodiment, the stereoscopic image generating system further includes an image object database for storing plural image data corresponding to the secondary capture target. The image generating module retrieves, according to the respective capture information in the first image and the second image, the image data from the image object database and further processes the image data as an image object placed in the first image and as the image object placed in the second image.

The image mixing module is for arranging, according to an arrangement criterion, the pixels of the first image, the pixels of the second image, the pixels of the image object placed in the first image and the pixels of the image object placed in the second image to generate a single mixed image.

Another aspect of the invention is to provide a stereoscopic image generating method including the following steps.

Firstly, a first image and a second image are captured at two different view angles, wherein the two images have a common primary capture target and a common secondary capture target.

Then, the common secondary target is identified.

Next, respective capture information of the secondary capture target in the first image and the second image are recognized.

Subsequently, an image object placed in the first image and the image object placed in the second image are generated according to the respective capture information in the first image and the second image.

Afterwards, the pixels of the first image, the pixels of the second image, the pixels of the image object placed in the first image, and the pixels of the image object placed in the second image are arranged, according to an arrangement criterion, to generate a single mixed image.

The advantage and spirit of the invention may be understood by the following recitations together with the appended drawings.

### BRIEF DESCRIPTION OF THE APPENDED DRAWINGS

FIG. 1 illustrates the function block diagram of the stereoscopic image generating system according to an embodiment of the invention.

FIG. 2A illustrates a schematic diagram of capturing an object by a first lens and a second lens of the image capturing module.

FIG. 2B and FIG. 2C illustrate the schematic diagrams of the first image and the second image captured by the first lens and the second lens.

FIG. 3 illustrates a schematic diagram of combining the first image and the image objects.

FIG. 4 illustrates a schematic diagram of combining the second image and the image objects.

FIG. 5 illustrates a schematic diagram of combining the combination image in FIG. 3 and the combination image in FIG. 4.

FIG. 6 illustrates a schematic diagram of observing the combination image in FIG. 5 at two predetermined angles.

FIG. 7 illustrates the flow chart of the stereoscopic image generating method according to an embodiment of the invention.

### DETAILED DESCRIPTION OF THE INVENTION

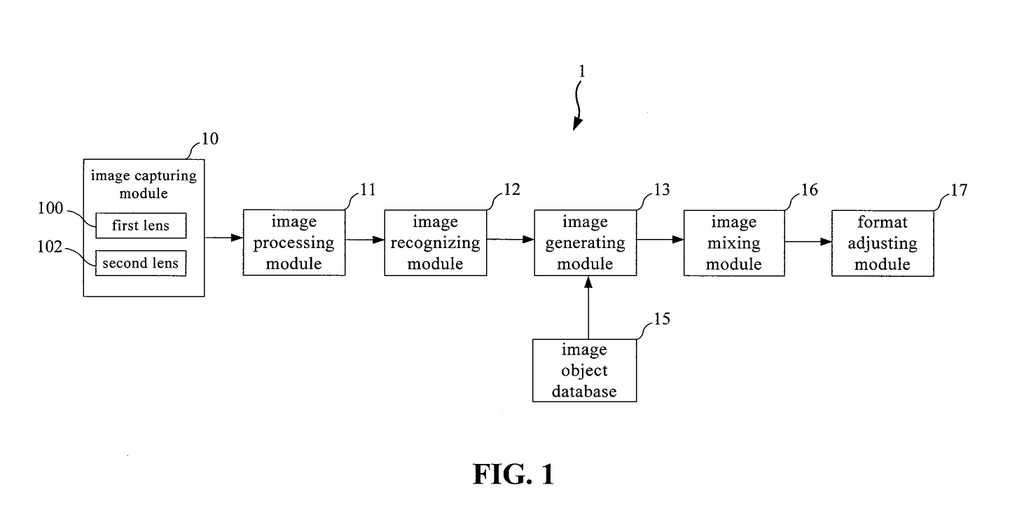

Please refer to FIG. 1 which illustrates the function block diagram of the stereoscopic image generating system 1 according to an embodiment of the invention.

As shown in FIG. 1, the stereoscopic image generating system 1 includes an image capturing module 10, an image processing module 11, an image recognizing module 12, an image object database 15, an image generating module 13, an image mixing module 16, and a format adjusting module 17. It should be noted that the image processing module 11, the image recognizing module 12, the image generating module 13, and the image mixing module 16 may be disposed in respective chips, in a single chip, or presented in the form of software programs.

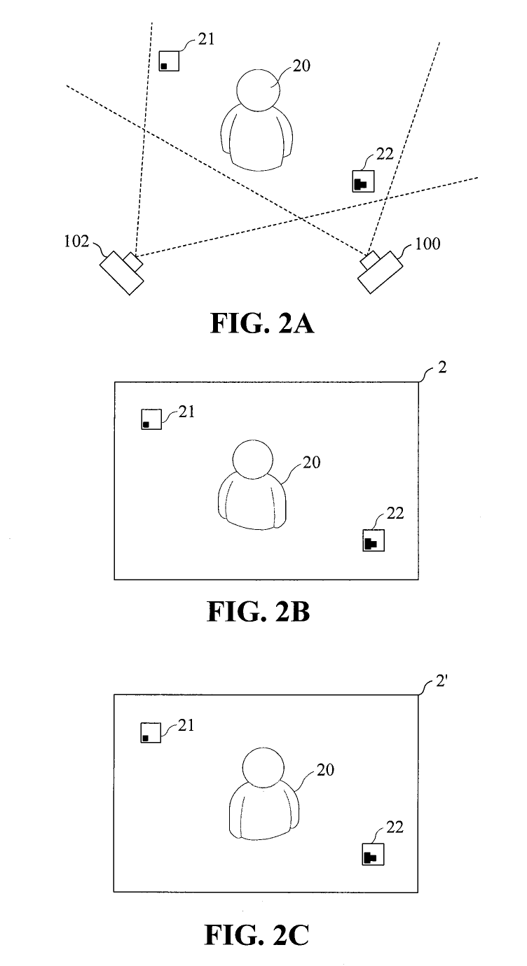

In practical applications, the image capturing module 10 can include a first lens 100 and a second lens 102. Please refer to FIG. 2A which illustrates a schematic diagram of capturing an object by the first lens 100 and the second lens 102 of the image capturing module 10. For example, the first lens 100 and the second lens 102 can capture the object simultaneously from the left and right sides of the object at 45 degrees. Please refer to FIG. 2B and FIG. 2C which illustrate the schematic diagrams of a first image 2 and a second image T captured by the first lens 100 and the second lens 102 respectively, wherein the two images have a common primary capture target 20, a common first secondary capture target 21, and a common second secondary capture target 22. It should be noted that the two common secondary capture targets in FIG. 2B and FIG. 2C are illustrated as an exemplification; in practical applications, the two images are not limited to have two common secondary capture targets.

The image processing module 11 is for performing a calibration procedure for the first image 2 and the second image 2′ in advance. For example, the first image 2 and the second image 2′ are aligned to each other based on a base plane, and the respective epipolar lines of the first image 2 and the second image 2′ are adjusted to be parallel to each other.

After the image capturing module 10 captures the first image 2 and the second image 2′, the image recognizing module 12 identifies the first secondary capture target 21 and the second secondary capture target 22. Then, the image recognizing module 12 recognizes respective capture information of the first secondary capture target 21 in the first image 2 and the second image 2′, and also recognizes respective capture information of the second secondary capture target 22 in the first image 2 and the second image 2′. It should be noted that the capture information includes orientation information and field depth information in the first image 2 and the second image 2′. For example, the capture information of the first secondary capture target 21 in the first image 2 includes the orientation information and field depth information of the first secondary capture target 21 in the first image 2.

In detail, the field depth information obtained by the image recognizing module 12 further includes space orientation matrix information. For example, referring to the orientation information and the field depth information of the first secondary capture target in the first image 2, the field depth information includes the space orientation matrix information of the first secondary capture target in the first image. The space orientation matrix information of the first secondary capture target in the second image 2′ is inferred in this way. Similarly, referring to the orientation information and the field depth information of the second secondary capture target in the first image 2, the field depth information includes the space orientation matrix information of the second secondary capture target in the first image 2. The space orientation matrix information of the second secondary capture target in the second image 2′ is inferred in this way.

In an embodiment, the image object database 15 is for storing plural image data corresponding to the first secondary capture target 21 and the second secondary capture target 22. The image generating module 13 retrieves the image data corresponding to the first secondary capture target 21 and the image data corresponding to the second secondary capture target 22 from the image object database 15. Afterwards, according to the respective capture information in the first image and the second image, the image generating module 13 processes the image data corresponding to the first secondary capture target 21 as a first image object placed in the first image and as the first image object placed in the second image; the image generating module 13 also processes the image data corresponding to the second secondary capture target 22 as a second image object placed in the first image and as the second image object placed in the second image.

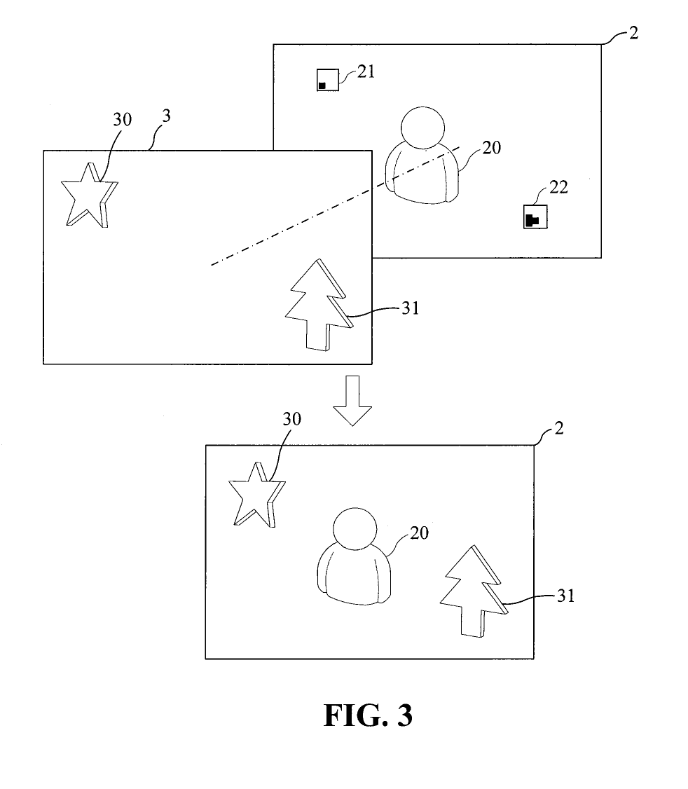

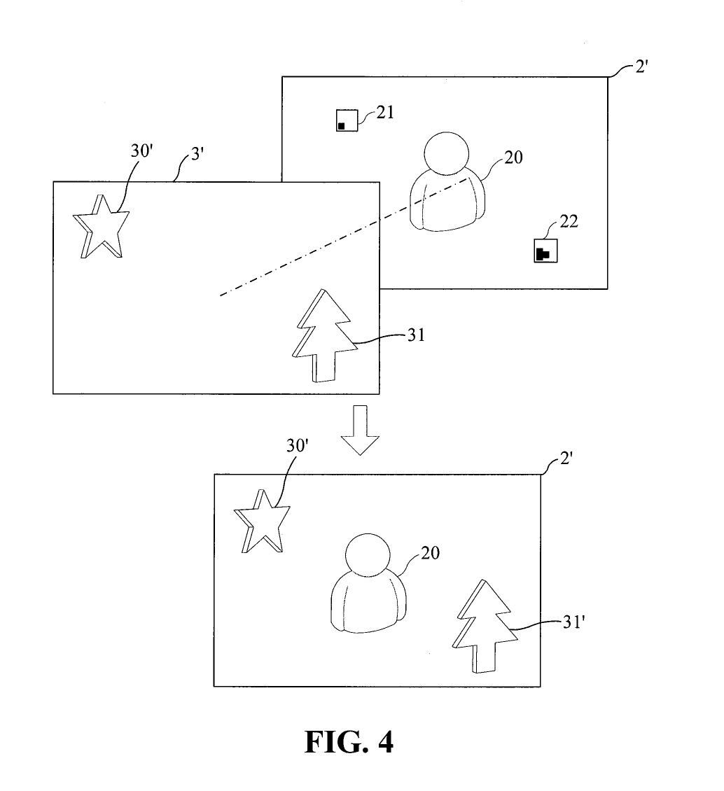

Thereby, as shown in FIG. 3 and FIG. 4, the image generating module 13 generates, according to the respective capture information in the first image 2 and the second image 2′, the first image object 30 placed in the first image 2 and the first image object 30′ placed in the second image 2′. Similarly, the image generating module 13 also generates, according to the respective capture information in the first image 2 and the second image 2′, the second image object 31 placed in the first image 2 and the second image object 31′ placed in the second image 2′. The image objects may have various kinds of patterns, such as the first image objects (30, 30′) having a star pattern and the second image objects (31, 31′) having a tree pattern. In addition, the first image object 30 and the second image object 31 can be involved in one object image 3, while the first image object 30′ and the second image object 31′ can be involved in the other object image 3′.

It should be noted that as shown in the embodiment of FIG. 2A FIG. 3 and FIG. 4, the image object database 15 can store two kinds of data; one is the data of the secondary capture target, and the other is the data of the image object, wherein the data of the secondary capture target is for the image recognizing module 12 to identify whether there is the secondary capture target existing in the first image and the second image. Moreover, the data of the secondary capture target in the database can assist in generating the capture information.

It should also be noted that if the secondary capture target is the famous spot, such as the Taipei 101, the Eiffel Tower, etc. in the real environment, the image object database 15 can store only one kind of data which can serve as the data of the secondary capture target and the data of the image object as well.

Subsequently, in an embodiment, the image mixing module 16 combines the first image 2 and the object image 3 together as shown in FIG. 3. In practice, the image mixing module 16 can firstly make the background of the object image 3 transparent but make each background of the first image object 30 and the second image object 31 opaque; then, the object image 3 is combined with the first image 2. Similarly, the image mixing module 16 combines the first image 2′ and the object image 3′ together as shown in FIG. 4.

Afterwards, the image mixing module 16 further combines the combination image in FIG. 3 with the combination image in FIG. 4. In detail, the image mixing module 16 is for arranging, according to an arrangement criterion, the pixels of the first image 2, the pixels of the second image 2′, the pixels of the first image object 30 placed in the first image, the pixels of the first image object 30′ placed in the second image, the pixels of the second image object 31 placed in the first image, and the pixels of the second image object 31′ placed in the second image to generate a single mixed image 2″.

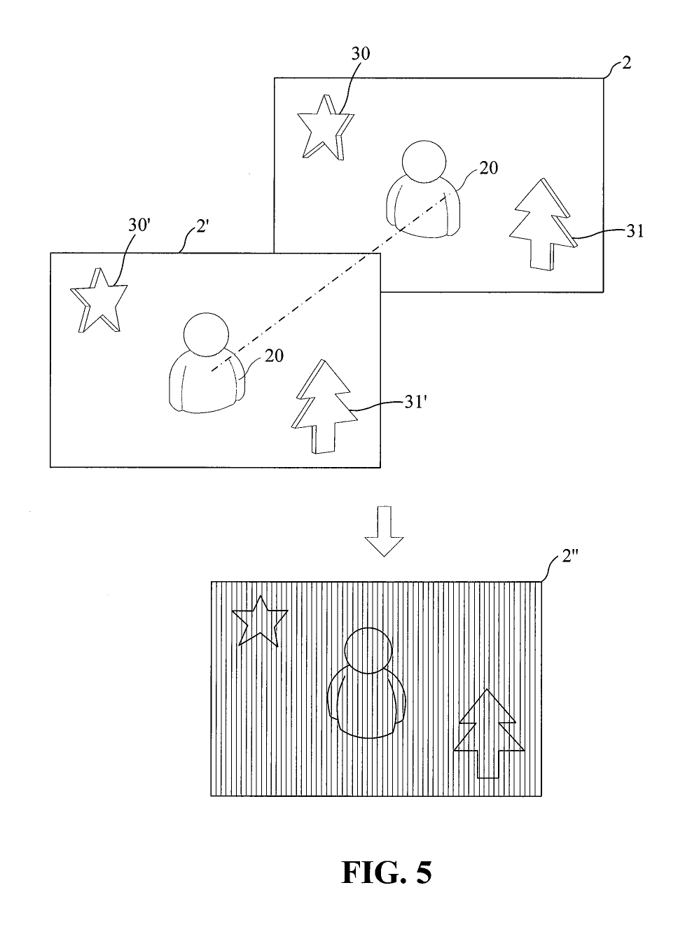

It should also be noted that if the mixed image 2″ is printed and observed through a lenticular sheet as shown in FIG. 5, the pixels of the above images and image objects can be arranged according to the optical quality of the lenticular sheet, e.g. the refraction behavior of light refracted by the column-like lens. If the mixed image 2″ is observed through a displayer, the pixels of the above images and image objects can be arranged according to the displaying quality of the displayer.

After the image mixing module 16 generates the mixed image 2″, the format adjusting module 17 may adjust the output format of the mixed image 2″ to conform to that of an ordinary displayer, a stereoscopic displayer, or a stereoscopic printer.

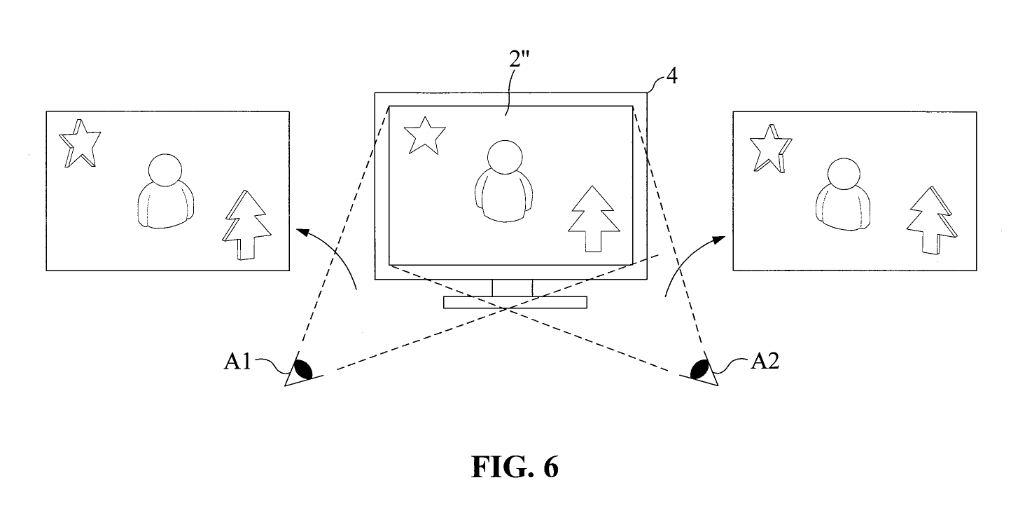

As shown in FIG. 6, the mixed image 2″ may be displayed on a stereoscopic displayer 4 in practical applications. A person can appreciate the combination image in FIG. 4 when standing on the right side at e.g. a 45-degree view angle A1 in front of the mixed image 2″; the person can appreciate the combination image in FIG. 3 when standing on the left side at e.g. a 45-degree view angle A2 in front of the mixed image 2″. Briefly speaking, when a person appreciates the mixed image at a predetermined view angle, he can experience the stereoscopic effects of the primary capture target and the accompanied image object.

In a further embodiment of the invention, the image generating module 13 further generates an interpolated image between the two different view angles, wherein the interpolated image has its orientation information and field depth information. It should be particularly explained that the orientation information of the interpolated image is obtained by an interpolated calculation based on the orientation information of the first image and the orientation information of the second image; the field depth information of the interpolated image is obtained by an interpolation calculation based on the field depth information of the first image and the field depth information of the second image. In addition to the interpolated image, the image generating module 13 further generates an interpolated first image object and an interpolated second image object between the two different view angles and corresponding to the interpolated image respectively, wherein each of the interpolated first image object and the interpolated second image object has the orientation information and the field depth information of the interpolated image.

In this embodiment, the image mixing module 16 further arranges the pixels of the first image, the pixels of the second image, the pixels of the first image object placed in the first image, the pixels of the first image object placed in the second image, the pixels of the second image object placed in the first image, the pixels of the second image object placed in the second image, the pixels of the interpolated image, the pixels of the interpolated first image object, and the pixels of the interpolated second image object to generate the single mixed image. Hence, a person can experience the stereoscopic effects of the primary capture target and the accompanied image object as long as appreciating the mixed image within, i.e. other than, the two view angles.

It should be noted that the image generating module 13 may generate plural interpolated image, plural interpolated first image objects, and plural interpolated second image objects within the two view angles, wherein each interpolated image has its orientation information and field depth information, while each of the interpolated first image object and the interpolated second image object applies the orientation information and field depth information of its corresponding interpolated image. Afterwards, the image mixing module 16 arranges all the pixels of the images and the image objects to generate the single mixed image.

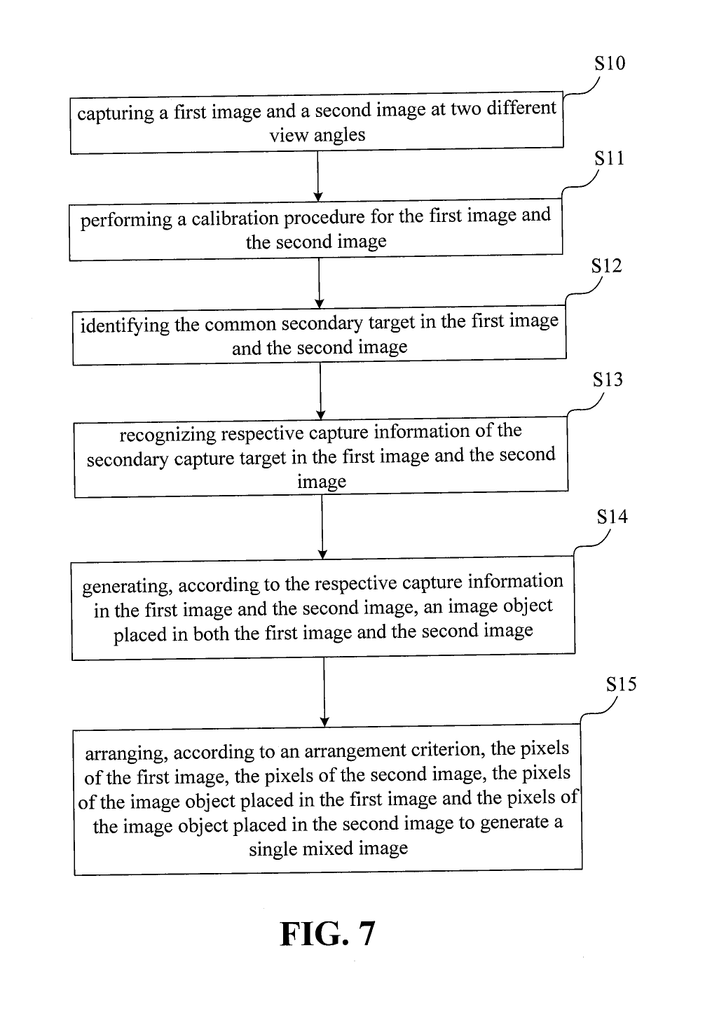

Please refer to FIG. 7 which illustrates the flow chart of the stereoscopic image generating method according to an embodiment of the invention. Please refer to FIGS. 1 to 6 together for a better understanding of the stereoscopic image generating method.

First, in executing step S10, a first image and a second image are captured at two different view angles, wherein the two images have a common primary capture target and a common secondary capture target. It should be noted that the two images have at least one common secondary capture target.

Then, in executing step S11, a calibration procedure mentioned above is performed for the first image and the second image.

Next, in executing step S12, the common secondary target in each of the first image and the second image is identified.

Subsequently, in executing step S13, respective capture information of the secondary capture target in the first image and the second image are recognized, wherein the capture information includes orientation information and field depth information. Besides, the field depth information further includes space orientation matrix information. For example, referring to the orientation information and the field depth information of the secondary capture target in the first image, the field depth information includes the space orientation matrix information of the secondary capture target in the first image.

In an embodiment, an image object database is provided for storing plural image data corresponding to the secondary capture target. Thereby, the image data corresponding to the secondary capture target is retrieved from the image object database.

Then, in executing step S14, an image object placed in the first image and the image object placed in the second image are generated according to the respective capture information in the first image and the second image.

Afterwards, in executing step S15, the pixels of the first image, the pixels of the second image, the pixels of the image object placed in the first image and the pixels of the image object placed in the second image are arranged, according to an arrangement criterion, to generate a single mixed image.

In a further embodiment, calculated orientation information is generated by an interpolated calculation based on the orientation information of the first image and the orientation information of the second image; calculated field depth information is generated by an interpolation calculation based on the field depth information of the first image and the field depth information of the second image. Then, an interpolated image is generated between the two different view angles, and the interpolated image has the calculated orientation information and the calculated field depth information.

In addition to the interpolated image, an interpolated image object is generated between the two different view angles, and the interpolated image object has the calculated orientation information and the calculated field depth information of the interpolated image. In this embodiment, the pixels of the first image, the pixels of the second image, the pixels of the image object placed in the first image, the pixels of the image object placed in the second image, the pixels of the interpolated image, and the pixels of the interpolated image object to generate the single mixed image.

Compared to the prior art, the present invention discloses that two images are captured at two different view angles and accompanied with image objects applying respective capture information of the two images such that the common primary capture target and the image objects can present stereoscopic effects. In addition, the present invention further discloses that the scene change between the two different view angles can be obtained by the image data acquired from image-capturing at the two different view angles, and the scene change can be involved in the final stereoscopic data. Therefore, a person can experience the stereoscopic effects of the primary capture target and the accompanied image objects as long as appreciating the mixed image within, i.e. other than, the two view angles.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A stereoscopic image generating system, comprising:
an image capturing module for capturing a first image and a second image at two different view angles, wherein the two images have a common primary capture target and a common first secondary capture target;
an image recognizing module for identifying the first secondary capture target and recognizing respective capture information of the first secondary capture target in the first image and the second image;
an image generating module for generating, according to the respective capture information in the first image and the second image, a first image object placed in both the first image and the second image; and
an image mixing module for arranging, according to an arrangement criterion, the pixels of the first image, the pixels of the second image, the pixels of the first image object placed in the first image and the pixels of the first image object placed in the second image to generate a single mixed image.

2. The stereoscopic image generating system of claim 1, wherein the capture information comprises orientation information and field depth information.

3. The stereoscopic image generating system of claim 2, wherein the field depth information comprises space orientation matrix information of the first secondary capture target in either the first image or the second image.

4. The stereoscopic image generating system of claim 1, further comprising:
an image object database for storing plural image data corresponding to the first secondary capture target, the image generating module retrieving, according to the respective capture information in the first image and the second image, the image data from the image object database and further processing the image data as the first image object placed in the first image and as the first image object placed in the second image.

5. The stereoscopic image generating system of claim 2, wherein the image generating module further generates an interpolated image between the two different view angles, the interpolated image has its orientation information and field depth information, the orientation information of the interpolated image is obtained by an interpolated calculation based on the orientation information of the first image and the orientation information of the second image, the field depth information of the interpolated image is obtained by an interpolation calculation based on the field depth information of the first image and the field depth information of the second image, the image mixing module arranges the pixels of the first image, the pixels of the second image, the pixels of the first image object placed in the first image, the pixels of the first image object placed in the second image, and the pixels of the interpolated image in the mixed image.

6. The stereoscopic image generating system of claim 5, wherein the image generating module further generates an interpolated first image object between the two different view angles, the interpolated first image object has the orientation information and the field depth information of the interpolated image, the image mixing module further arranges the pixels of the first image, the pixels of the second image, the pixels of the first image object placed in the first image, the pixels of the first image object placed in the second image, the pixels of the interpolated image, and the pixels of the interpolated first image object in the mixed image.

7. The stereoscopic image generating system of claim 1, further comprising:
an image processing module for performing a calibration procedure for the first image and the second image.

8. The stereoscopic image generating system of claim 1, further comprising:
a format adjusting module for adjusting, according to an output apparatus which presents the mixed image, an output format of the mixed image.

9. The stereoscopic image generating system of claim 1, wherein the common primary capture target is stereoscopic.

10. The stereoscopic image generating system of claim 1, wherein the first image and the second image further have a common second secondary capture target, the image recognizing module identifies the second secondary capture target and recognizes respective capture information of the second secondary capture target in the first image and the second image, the image generating module generates, according to the respective capture information of the second secondary capture target in the first image and the second image, a second image object placed in both the first image and the second image, the image mixing module arranges the pixels of the first image, the pixels of the second image, the pixels of the first image object placed in the first image, the pixels of the first image object placed in the second image, the pixels of the second image object placed in the first image, the pixels of the second image object placed in the second image, to generate the single mixed image.

11. A stereoscopic image generating method, comprising the following steps:
capturing a first image and a second image at two different view angles, wherein the two images have a common primary capture target and a common first secondary capture target;
identifying the common first secondary target;
recognizing respective capture information of the first secondary capture target in the first image and the second image;
generating, according to the respective capture information in the first image and the second image, a first image object placed in both the first image and the second image; and
arranging, according to an arrangement criterion, the pixels of the first image, the pixels of the second image, the pixels of the first image object placed in the first image and the pixels of the first image object placed in the second image to generate a single mixed image.

12. The stereoscopic image generating method of claim 11, wherein the capture information comprises orientation information and field depth information.

13. The stereoscopic image generating method of claim 12, wherein the field depth information comprises space orientation matrix information of the first secondary capture target in either the first image or the second image.

14. The stereoscopic image generating method of claim 11, further comprising the following steps:
providing an image object database for storing plural image data corresponding to the first secondary capture target; and
retrieving, according to the respective capture information in the first image and the second image, the image data from the image object database and further processing the image data as the first image object placed in the first image and as the first image object placed in the second image.

15. The stereoscopic image generating method of claim 12, further comprising the following steps:
generating calculated orientation information by an interpolated calculation based on the orientation information of the first image and the orientation information of the second image, generating calculated field depth information by an interpolation calculation based on the field depth information of the first image and the field depth information of the second image;
generating an interpolated image having the calculated orientation information and the calculated field depth information between the two different view angles; and
arranging the pixels of the first image, the pixels of the second image, the pixels of the first image object placed in the first image, the pixels of the first image object placed in the second image, and the pixels of the interpolated image in the mixed image.

16. The stereoscopic image generating method of claim 15, further comprising the following steps:
generating an interpolated first image object between the two different view angles, the interpolated first image object having the calculated orientation information and the calculated field depth information of the interpolated image; and
arranging the pixels of the first image, the pixels of the second image, the pixels of the first image object placed in the first image, the pixels of the first image object placed in the second image, the pixels of the interpolated image, and the pixels of the interpolated first image object in the mixed image.

17. The stereoscopic image generating method of claim 11, further comprising the following step:
performing a calibration procedure for the first image and the second image.

18. The stereoscopic image generating method of claim 11, further comprising the following step:
adjusting, according to an output apparatus which presents the mixed image, an output format of the mixed image.

19. The stereoscopic image generating method of claim 11, wherein the common primary capture target is stereoscopic.

20. The stereoscopic image generating method of claim 11, wherein the first image and the second image further have a common second secondary capture target, the method further comprising the following steps:
identifying the second secondary capture target;
recognizing respective capture information of the second secondary capture target in the first image and the second image;
generating, according to the respective capture information of the second secondary capture target in the first image and the second image, a second image object placed in both the first image and the second image; and
arranging the pixels of the first image, the pixels of the second image, the pixels of the first image object placed in the first image, the pixels of the first image object placed in the second image, the pixels of the second image object placed in the first image, the pixels of the second image object placed in the second image, to generate the single mixed image.
